(19) United States
(12) Patent Application Publication
(10) Pub. No.: US 2025/0193101 A1
(43) Pub. Date: Jun. 12, 2025

(54) LOCAL PROTOCOL DATA UNIT (PDU) SESSION ANCHOR (PSA) SELECTION BASED ON N6 DELAY

(71) Applicant: Intel Corporation, Santa Clara, CA (US)

(72) Inventor: Changhong Shan, Shanghai (CN)

(21) Appl. No.: 19/053,279

(22) Filed: Feb. 13, 2025

(30) Foreign Application Priority Data
Feb. 14, 2024 (WO) PCT/CN2024/077192

(51) Int. Cl. H04L 43/0864; H04L 41/0806

(52) U.S. Cl. CPC H04L 43/0864; H04L 41/0806

(57) ABSTRACT

Various embodiments herein relate to a session management function (SMF). The SMF may be configured to identify, in a notification received from a Local protocol data unit session anchor (PSA), an indication of a transmission delay between the Local PSA and an edge application server (EAS) via an N6 interface. The SMF may then be configured to establish the Local PSA in a Local PSA insertion procedure based on the transmission delay. Other embodiments may be described and/or claimed.

### CROSS REFERENCE TO RELATED APPLICATION

The present application claims priority to International Patent Application No. PCT/CN2024/077192, which was filed Feb. 14, 2024, the disclosure of which is hereby incorporated by reference.

### BACKGROUND

Various embodiments generally may relate to the field of wireless communications.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates a procedure for addition of an additional protocol data unit (PDU) session anchor (collectively, “PSA”) and branching point or uplink (UL) classifier (CL) (e.g., as defined in the third generation partnership project (3GPP) Technical Standard (TS) 23.502, Section 4.3.5.4).

FIG. 2 illustrates a procedure for N6 delay subscription and notification, in accordance with various embodiments.

FIG. 3 illustrates a network in accordance with various embodiments.

FIG. 4 schematically illustrates a wireless network in accordance with various embodiments.

FIG. 5 is a block diagram illustrating components, according to some example embodiments, able to read instructions from a machine-readable or computer-readable medium (e.g., a non-transitory machine-readable storage medium) and perform any one or more of the methodologies discussed herein.

FIG. 6 illustrates a network in accordance with various embodiments.

FIG. 7 depicts an example procedure for practicing the various embodiments discussed herein.

FIG. 8 depicts another example procedure for practicing the various embodiments discussed herein.

FIG. 9 depicts another example procedure for practicing the various embodiments discussed herein.

FIG. 10 depicts another example procedure for practicing the various embodiments herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B). Unless used differently herein, terms, definitions, and abbreviations may be consistent with terms, definitions, and abbreviations defined in 3GPP technical report (TR) 21.905.

A Release-19 (Rel-19) study on enhancement for support of Edge Computing in the fifth generation (5G) Core network—Phase 3 (3GPP TR 23.700-49) identified the following:

Normally an edge application can be served by different [[edge application servers (EASs)]] deployed in different sites. It is important to discover one suitable EAS to handle the edge application, especially considering that mostly the edge application have the stringent E2E delay and/or data rate requirement(s) which may depend not only on network metrics such as bandwidth and latency but also on compute metrics such as processing, storage capabilities, and capacity as indicators for EAS load. When multiple candidate paths to application service are available for selection of an optimal service instance, the topologically closest path may not always meet the service specific requirements and metrics. For instance, some of the available links may be congested. Moreover, once a discovered EAS becomes non-optimized (e.g. after the UE moves far away or excessive load on EAS), a new EAS and local PSA might need to be reselected to replace the old ones to serve the UE.

In the existing design, 5GS provides support for means to determine, to report and to expose UE on-path congestions status, date rate information and round-trip delay between UE and PSA UPF. However, no means are defined to also consider above metrics on data network (e.g. N6 delay) when multiple EAS instance(s) are available for selection to provide best possible E2E user experience.

The purpose of this key issue is to investigate whether and how to enhance EAS and local UPF (re)selection considering dynamic information related to EAS (i.e. EAS load and N6 delay between the local PSA and EAS).

The following aspects shall be studied:
How to enable 5GC and/or a third party trusted and/or non-trusted Application Function to select the most suitable local UPF and EAS considering end to end delay that includes delay between a candidate N6 interface of the 5GS and a candidate EAS, and/or potentially EAS load.
Whether and how to define N6 delay information (e.g. RTT).
Whether considering the EAS load is needed, and if it is needed how the information representing the EAS load would be defined.
For local UPF and EAS (re)selection, whether and how to take into account potentially EAS load and N6 Delay between the local PSA and EAS, including how to obtain and update the above information.

Various embodiments herein may relate to the above issues and/or other issues. For example, some embodiments may relate to EAS discovery taking into account EAS load information. In some embodiments, the EAS load information may be stored in, for example, a domain name system (DNS) server, an EAS discovery function (EASDF), a session management function (SMF), etc. Some embodiments may additionally or alternatively include or relate to local protocol data unit (PDU) session anchor (PSA) selection based on N6 delay information (e.g., between the Local PSA and an edge application server (EAS).

In some embodiments, the session management function SMF may be located in a central location (e.g., in the core network (CN) of a wireless network), or in a local location (e.g., at a base station/access point of the wireless network or elsewhere). Generally, as used herein, the term “Local” may be used to refer to an Application Function that is instantiated and/or replicated in a device that is intermediate to the CN and the user. Such functions may be at the “Edge” of the CN, and may be located at, for example, a base station, an access point, etc.

The SMF may subscribe to a managed Local PSA user plane function (UPF) to be notified about N6 delay information. As used herein, a PSA may refer to a specific type of UPF that terminates the N6 interface of a PDU session within the CN. In embodiments herein, the PSA may be a “Local” PSA, and will be described as such. However, it will be understood that in other embodiments the PSA may be additionally or alternatively implemented as a different element of the CN. As used herein, the terms “PSA,” “Local PSA,” and “Local PSA UPF” may be used interchangeably.

Additionally, as used herein, the term “subscribe” may indicate that the SMF and/or PSA have been configured (e.g., the SMF has configured the PSA, the SMF has been configured by the PSA, the SMF and/or PSA have been pre-configured by a network administrator, etc.) such that the PSA provides information regarding the N6 delay to the SMF. In some embodiments, such provision may be a “push” operation by the PSA. In some embodiments, such provision may additionally/alternatively be a “pull” operation by the SMF. Other embodiments may vary. In some embodiments, the Local PSA may provide such information regarding N6 delay between the PSA and the EAS periodically (e.g., upon expiration of a configured time interval). In some embodiments, the PSA may provide such information based on a N6 delay change range. Specifically, if the change in the N6 delay is beyond a configured or pre-configured value, then the PSA may provide an indication of the N6 delay. Such provision may be indicated as an absolute value of the N6 delay, or an amount of change from a previously-provided value of the N6 delay. In some embodiments, the PSA may provide such information based on an absolute value of the N6 delay exceeding a configured or pre-configured value. Each of these conditions may be referred to herein as a “notification trigger,” and it will be understood that such descriptions are provided herein for the sake of discussion and example, and are not intended to be limiting.

When the notification trigger is met, the Local PSA UPF may provide an indication of the N6 delay information to the SMF (e.g., the local SMF or the centralized SMF). In some embodiments, provision of the such delay information may include transmission, from the Local PSA UPF, of an indication regarding the N6 delay information to the SMF. In some embodiments, In embodiments, the N6 delay information between the Local PSA UPF and the EAS may be represented in milliseconds of the Round-trip time (RTT). Specifically, the N6 delay information may include or relate to the time that it takes a first signal to be transmitted from the Local PSA UPF to the EAS via the N6 interface, and then for a second signal to be transmitted from the EAS to the Local PSA UPF via the N6 interface (or vice-versa). However, in some embodiments, the N6 delay information may be based on a unidirectional measurement (e.g., the time that it takes for a signal to be transmitted from one of the Local PSA UPF and the EAS to the other via the N6 interface).

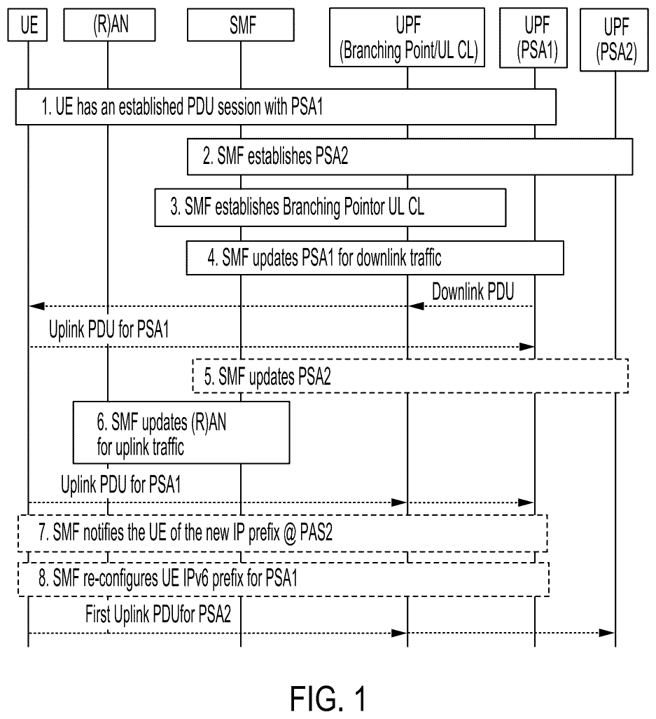

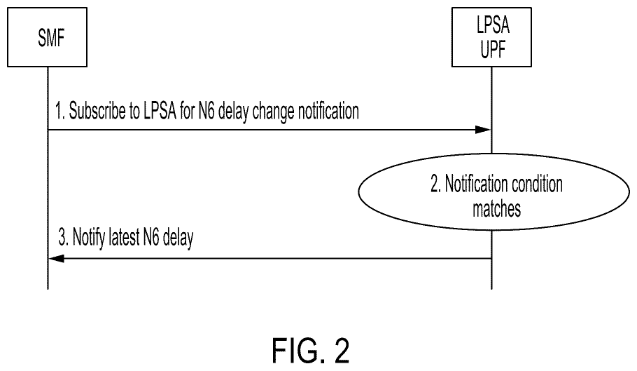

FIG. 1 depicts an example of a UL CL UPF and Local PSA insertion procedure, for example as may be defined in clause 4.3.5.4 of 3GPP TS 23.502. At element 2 of the Figure, the SMF may establish a second PSA (PSA2). PSA2, as shown in FIG. 1, may refer to the Local PSA described herein. In some embodiments, the SMF may identify the N6 delay that is related to a plurality of Local PSAs. For example, as previously described and as described in further detail with respect to FIG. 2, the Local PSA(s) may notify the SMF of the N6 delay between a Local PSA and an EAS. Based on this N6 delay, the SMF may identify which PSA of the plurality of Local PSAs should be selected as PSA2.

FIG. 2 depicts an example procedure related to subscription, by the SMF, to notifications from a Local PSA (depicted in FIG. 2 as LPSA UPF) of N6 delay between the Local PSA and an EAS.

At element 1, the SMF may transmit an indication to a Local PSA. The indication may be a subscription indication which indicates that the SMF is to subscribe to notifications from the Local PSA regarding delay between the Local PSA that regarding the N6 delay between the Local PSA and an EAS, for example as described above. In some embodiments, the Local PSA may be communicatively coupled with a plurality of EASs via one or more N6 interfaces. In this situation, the SMF may transmit one or more indications regarding one or more subscriptions to notifications of N6 delay between the Local PSA and ones of the plurality of EASs (e.g., one notification regarding a plurality of subscriptions, a plurality of notifications regarding a plurality of subscriptions, etc.).

At element 2, a Local PSA to which the SMF is subscribed may monitor for a trigger condition that triggers a transmission of a N6 delay notification to the SMF. The trigger condition may be, for example, a time interval, a delay change range, comparison to a delay threshold, comparison to a threshold related to change in delay, expiration of a timer, etc.

At element 3, once the Local PSA identifies that the condition has occurred at element 2, then the Local PSA may notify the SMF of the N6 delay between the Local PSA and the EAS to which the Local PSA is coupled.

In embodiments where the Local PSA is coupled with the plurality of EASs, respective EASs may be identified by an EAS identifier. The EAS identifier may be or include, for example, one or more of an EAS fully qualified domain name (FQDN)(s), FQDN range, internet protocol (IP) address(es), IP range, etc.

### Systems and Implementations

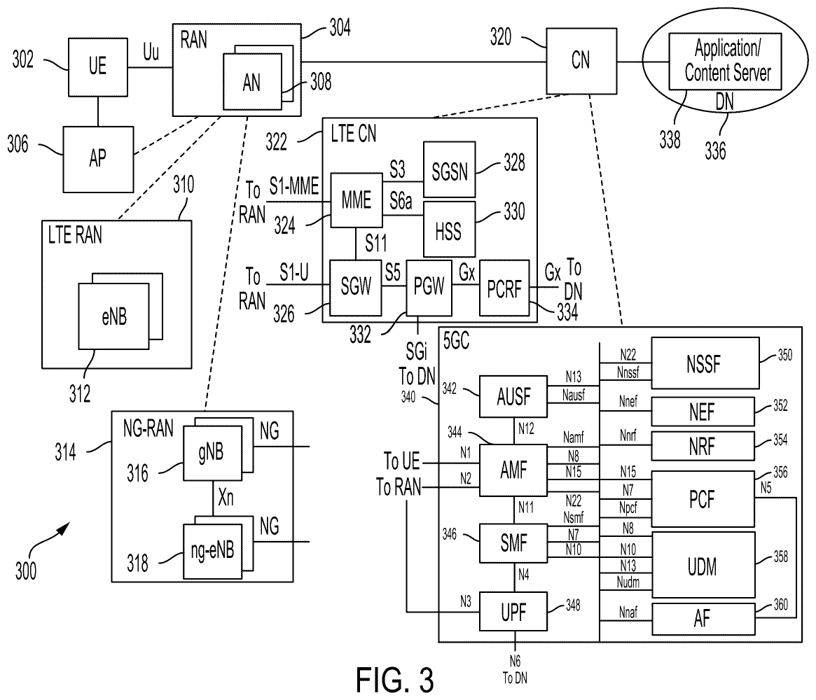

FIGS. 3-6 illustrate various systems, devices, and components that may implement aspects of disclosed embodiments.

FIG. 3 illustrates a network 300 in accordance with various embodiments. The network 300 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 300 may include a UE 302, which may include any mobile or non-mobile computing device designed to communicate with a RAN 304 via an over-the-air connection. The UE 302 may be communicatively coupled with the RAN 304 by a Uu interface. The UE 302 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 300 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 302 may additionally communicate with an AP 306 via an over-the-air connection. The AP 306 may manage a WLAN connection, which may serve to offload some/all network traffic from the RAN 304. The connection between the UE 302 and the AP 306 may be consistent with any IEEE 802.11 protocol, wherein the AP 306 could be a wireless fidelity (Wi-Fi®) router. In some embodiments, the UE 302, RAN 304, and AP 306 may utilize cellular-WLAN aggregation (for example, LWA/LWIP). Cellular-WLAN aggregation may involve the UE 302 being configured by the RAN 304 to utilize both cellular radio resources and WLAN resources.

The RAN 304 may include one or more access nodes, for example, AN 308. AN 308 may terminate air-interface protocols for the UE 302 by providing access stratum protocols including RRC, PDCP, RLC, MAC, and L1 protocols. In this manner, the AN 308 may enable data/voice connectivity between CN 320 and the UE 302. In some embodiments, the AN 308 may be implemented in a discrete device or as one or more software entities running on server computers as part of, for example, a virtual network, which may be referred to as a CRAN or virtual baseband unit pool. The AN 308 be referred to as a BS, gNB, RAN node, eNB, ng-eNB, NodeB, RSU, TRxP, TRP, etc. The AN 308 may be a macrocell base station or a low power base station for providing femtocells, picocells or other like cells having smaller coverage areas, smaller user capacity, or higher bandwidth compared to macrocells.

In embodiments in which the RAN 304 includes a plurality of ANs, they may be coupled with one another via an X2 interface (if the RAN 304 is an LTE RAN) or an Xn interface (if the RAN 304 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 304 may each manage one or more cells, cell groups, component carriers, etc. to provide the UE 302 with an air interface for network access. The UE 302 may be simultaneously connected with a plurality of cells provided by the same or different ANs of the RAN 304. For example, the UE 302 and RAN 304 may use carrier aggregation to allow the UE 302 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 304 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 302 or AN 308 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 304 may be an LTE RAN 310 with eNBs, for example, eNB 312. The LTE RAN 310 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 304 may be an NG-RAN 314 with gNBs, for example, gNB 316, or ng-eNBs, for example, ng-eNB 318. The gNB 316 may connect with 5G-enabled UEs using a 5G NR interface. The gNB 316 may connect with a 5G core through an NG interface, which may include an N2 interface or an N3 interface. The ng-eNB 318 may also connect with the 5G core through an NG interface, but may connect with a UE via an LTE air interface. The gNB 316 and the ng-eNB 318 may connect with each other over an Xn interface.

In some embodiments, the NG interface may be split into two parts, an NG user plane (NG-U) interface, which carries traffic data between the nodes of the NG-RAN 314 and a UPF 348 (e.g., N3 interface), and an NG control plane (NG-C) interface, which is a signaling interface between the nodes of the NG-RAN314 and an AMF 344 (e.g., N2 interface).

The NG-RAN 314 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 302 can be configured with multiple BWPs where each BWP configuration has a different SCS. When a BWP change is indicated to the UE 302, the SCS of the transmission is changed as well. Another use case example of BWP is related to power saving. In particular, multiple BWPs can be configured for the UE 302 with different amount of frequency resources (for example, PRBs) to support data transmission under different traffic loading scenarios. A BWP containing a smaller number of PRBs can be used for data transmission with small traffic load while allowing power saving at the UE 302 and in some cases at the gNB 316. A BWP containing a larger number of PRBs can be used for scenarios with higher traffic load.

The RAN 304 is communicatively coupled to CN 320 that includes network elements to provide various functions to support data and telecommunications services to customers/subscribers (for example, users of UE 302). The components of the CN 320 may be implemented in one physical node or separate physical nodes. In some embodiments, NFV may be utilized to virtualize any or all of the functions provided by the network elements of the CN 320 onto physical compute/storage resources in servers, switches, etc. A logical instantiation of the CN 320 may be referred to as a network slice, and a logical instantiation of a portion of the CN 320 may be referred to as a network sub-slice.

In some embodiments, the CN 320 may be an LTE CN 322, which may also be referred to as an EPC. The LTE CN 322 may include MME 324, SGW 326, SGSN 328, HSS 330, PGW 332, and PCRF 334 coupled with one another over interfaces (or “reference points”) as shown. Functions of the elements of the LTE CN 322 may be briefly introduced as follows.

The MME 324 may implement mobility management functions to track a current location of the UE 302 to facilitate paging, bearer activation/deactivation, handovers, gateway selection, authentication, etc.

The SGW 326 may terminate an S1 interface toward the RAN and route data packets between the RAN and the LTE CN 322. The SGW 326 may be a local mobility anchor point for inter-RAN node handovers and also may provide an anchor for inter-3GPP mobility. Other responsibilities may include lawful intercept, charging, and some policy enforcement.

The SGSN 328 may track a location of the UE 302 and perform security functions and access control. In addition, the SGSN 328 may perform inter-EPC node signaling for mobility between different RAT networks; PDN and S-GW selection as specified by MME 324; MME selection for handovers; etc. The S3 reference point between the MME 324 and the SGSN 328 may enable user and bearer information exchange for inter-3GPP access network mobility in idle/active states.

The HSS 330 may include a database for network users, including subscription-related information to support the network entities' handling of communication sessions. The HSS 330 can provide support for routing/roaming, authentication, authorization, naming/addressing resolution, location dependencies, etc. An S6a reference point between the HSS 330 and the MME 324 may enable transfer of subscription and authentication data for authenticating/authorizing user access to the LTE CN 320.

The PGW 332 may terminate an SGi interface toward a data network (DN) 336 that may include an application/content server 338. The PGW 332 may route data packets between the LTE CN 322 and the data network 336. The PGW 332 may be coupled with the SGW 326 by an S5 reference point to facilitate user plane tunneling and tunnel management. The PGW 332 may further include a node for policy enforcement and charging data collection (for example, PCEF). Additionally, the SGi reference point between the PGW 332 and the data network 3 36 may be an operator external public, a private PDN, or an intra-operator packet data network, for example, for provision of IMS services. The PGW 332 may be coupled with a PCRF 334 via a Gx reference point.

The PCRF 334 is the policy and charging control element of the LTE CN 322. The PCRF 334 may be communicatively coupled to the app/content server 338 to determine appropriate QoS and charging parameters for service flows. The PCRF 332 may provision associated rules into a PCEF (via Gx reference point) with appropriate TFT and QCI.

In some embodiments, the CN 320 may be a 5GC 340. The 5GC 340 may include an AUSF 342, AMF 344, SMF 346, UPF 348, NSSF 350, NEF 352, NRF 354, PCF 356, UDM 358, and AF 360 coupled with one another over interfaces (or “reference points”) as shown. Functions of the elements of the 5GC 340 may be briefly introduced as follows.

The AUSF 342 may store data for authentication of UE 302 and handle authentication-related functionality. The AUSF 342 may facilitate a common authentication framework for various access types. In addition to communicating with other elements of the 5GC 340 over reference points as shown, the AUSF 342 may exhibit an Nausf service-based interface.

The AMF 344 may allow other functions of the 5GC 340 to communicate with the UE 302 and the RAN 304 and to subscribe to notifications about mobility events with respect to the UE 302. The AMF 344 may be responsible for registration management (for example, for registering UE 302), connection management, reachability management, mobility management, lawful interception of AMF-related events, and access authentication and authorization. The AMF 344 may provide transport for SM messages between the UE 302 and the SMF 346, and act as a transparent proxy for routing SM messages. AMF 344 may also provide transport for SMS messages between UE 302 and an SMSF. AMF 344 may interact with the AUSF 342 and the UE 302 to perform various security anchor and context management functions. Furthermore, AMF 344 may be a termination point of a RAN CP interface, which may include or be an N2 reference point between the RAN 304 and the AMF 344; and the AMF 344 may be a termination point of NAS (N1) signaling, and perform NAS ciphering and integrity protection. AMF 344 may also support NAS signaling with the UE 302 over an N3 IWF interface.

The SMF 346 may be responsible for SM (for example, session establishment, tunnel management between UPF 348 and AN 308); UE IP address allocation and management (including optional authorization); selection and control of UP function; configuring traffic steering at UPF 348 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 344 over N2 to AN 308; and determining SSC mode of a session. SM may refer to management of a PDU session, and a PDU session or “session” may refer to a PDU connectivity service that provides or enables the exchange of PDUs between the UE 302 and the data network 336.

The UPF 348 may act as an anchor point for intra-RAT and inter-RAT mobility, an external PDU session point of interconnect to data network 336, and a branching point to support multi-homed PDU session. The UPF 348 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 348 may include an uplink classifier to support routing traffic flows to a data network.

The NSSF 350 may select a set of network slice instances serving the UE 302. The NSSF 350 may also determine allowed NSSAI and the mapping to the subscribed S-NSSAIs, if needed. The NSSF 350 may also determine the AMF set to be used to serve the UE 302, or a list of candidate AMFs based on a suitable configuration and possibly by querying the NRF 354. The selection of a set of network slice instances for the UE 302 may be triggered by the AMF 344 with which the UE 302 is registered by interacting with the NSSF 350, which may lead to a change of AMF. The NSSF 350 may interact with the AMF 344 via an N22 reference point; and may communicate with another NSSF in a visited network via an N31 reference point (not shown). Additionally, the NSSF 350 may exhibit an Nnssf service-based interface.

The NEF 352 may securely expose services and capabilities provided by 3GPP network functions for third party, internal exposure/re-exposure, AFs (e.g., AF 360), edge computing or fog computing systems, etc. In such embodiments, the NEF 352 may authenticate, authorize, or throttle the AFs. NEF 352 may also translate information exchanged with the AF 360 and information exchanged with internal network functions. For example, the NEF 352 may translate between an AF-Service-Identifier and an internal 5GC information. NEF 352 may also receive information from other NFs based on exposed capabilities of other NFs. This information may be stored at the NEF 352 as structured data, or at a data storage NF using standardized interfaces. The stored information can then be re-exposed by the NEF 352 to other NFs and AFs, or used for other purposes such as analytics. Additionally, the NEF 352 may exhibit an Nnef service-based interface.

The NRF 354 may support service discovery functions, receive NF discovery requests from NF instances, and provide the information of the discovered NF instances to the NF instances. NRF 354 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 354 may exhibit the Nnrf service-based interface.

The PCF 356 may provide policy rules to control plane functions to enforce them, and may also support unified policy framework to govern network behavior. The PCF 356 may also implement a front end to access subscription information relevant for policy decisions in a UDR of the UDM 358. In addition to communicating with functions over reference points as shown, the PCF 356 exhibit an Npcf service-based interface.

The UDM 358 may handle subscription-related information to support the network entities' handling of communication sessions, and may store subscription data of UE 302. For example, subscription data may be communicated via an N8 reference point between the UDM 358 and the AMF 344. The UDM 358 may include two parts, an application front end and a UDR. The UDR may store subscription data and policy data for the UDM 358 and the PCF 356, and/or structured data for exposure and application data (including PFDs for application detection, application request information for multiple UEs 302) for the NEF 352. The Nudr service-based interface may be exhibited by the UDR 221 to allow the UDM 358, PCF 356, and NEF 352 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 358 may exhibit the Nudm service-based interface.

The AF 360 may provide application influence on traffic routing, provide access to NEF, and interact with the policy framework for policy control.

In some embodiments, the 5GC 340 may enable edge computing by selecting operator/3rd party services to be geographically close to a point that the UE 302 is attached to the network. This may reduce latency and load on the network. To provide edge-computing implementations, the 5GC 340 may select a UPF 348 close to the UE 302 and execute traffic steering from the UPF 348 to data network 336 via the N6 interface. This may be based on the UE subscription data, UE location, and information provided by the AF 360. In this way, the AF 360 may influence UPF (re)selection and traffic routing. Based on operator deployment, when AF 360 is considered to be a trusted entity, the network operator may permit AF 360 to interact directly with relevant NFs. Additionally, the AF 360 may exhibit an Naf service-based interface.

The data network 336 may represent various network operator services, Internet access, or third party services that may be provided by one or more servers including, for example, application/content server 338.

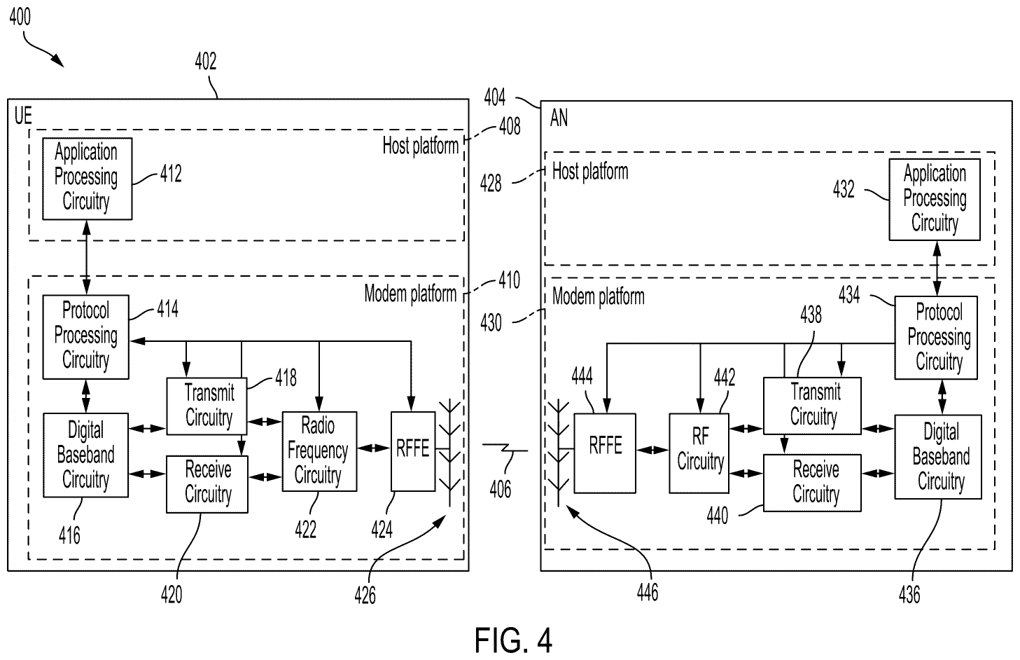

FIG. 4 schematically illustrates a wireless network 400 in accordance with various embodiments. The wireless network 400 may include a UE 402 in wireless communication with an AN 404. The UE 402 and AN 404 may be similar to, and substantially interchangeable with, like-named components described elsewhere herein.

The UE 402 may be communicatively coupled with the AN 404 via connection 406. The connection 406 is illustrated as an air interface to enable communicative coupling, and can be consistent with cellular communications protocols such as an LTE protocol or a 5G NR protocol operating at mmWave or sub-6GHZ frequencies.

The UE 402 may include a host platform 408 coupled with a modem platform 410. The host platform 408 may include application processing circuitry 412, which may be coupled with protocol processing circuitry 414 of the modem platform 410. The application processing circuitry 412 may run various applications for the UE 402 that source/sink application data. The application processing circuitry 412 may further implement one or more layer operations to transmit/receive application data to/from a data network. These layer operations may include transport (for example UDP) and Internet (for example, IP) operations

The protocol processing circuitry 414 may implement one or more of layer operations to facilitate transmission or reception of data over the connection 406. The layer operations implemented by the protocol processing circuitry 414 may include, for example, MAC, RLC, PDCP, RRC and NAS operations.

The modem platform 410 may further include digital baseband circuitry 416 that may implement one or more layer operations that are “below” layer operations performed by the protocol processing circuitry 414 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 410 may further include transmit circuitry 418, receive circuitry 420, RF circuitry 422, and RF front end (RFFE) 424, which may include or connect to one or more antenna panels 426. Briefly, the transmit circuitry 418 may include a digital-to-analog converter, mixer, intermediate frequency (IF) components, etc.; the receive circuitry 420 may include an analog-to-digital converter, mixer, IF components, etc.; the RF circuitry 422 may include a low-noise amplifier, a power amplifier, power tracking components, etc.; RFFE 424 may include filters (for example, surface/bulk acoustic wave filters), switches, antenna tuners, beamforming components (for example, phase-array antenna components), etc. The selection and arrangement of the components of the transmit circuitry 418, receive circuitry 420, RF circuitry 422, RFFE 424, and antenna panels 426 (referred generically as “transmit/receive components”) may be specific to details of a specific implementation such as, for example, whether communication is TDM or FDM, in mm Wave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 414 may include one or more instances of control circuitry (not shown) to provide control functions for the transmit/receive components.

A UE reception may be established by and via the antenna panels 426, RFFE 424, RF circuitry 422, receive circuitry 420, digital baseband circuitry 416, and protocol processing circuitry 414. In some embodiments, the antenna panels 426 may receive a transmission from the AN 404 by receive-beamforming signals received by a plurality of antennas/antenna elements of the one or more antenna panels 426.

A UE transmission may be established by and via the protocol processing circuitry 414, digital baseband circuitry 416, transmit circuitry 418, RF circuitry 422, RFFE 424, and antenna panels 426. In some embodiments, the transmit components of the UE 404 may apply a spatial filter to the data to be transmitted to form a transmit beam emitted by the antenna elements of the antenna panels 426.

Similar to the UE 402, the AN 404 may include a host platform 428 coupled with a modem platform 430. The host platform 428 may include application processing circuitry 432 coupled with protocol processing circuitry 434 of the modem platform 430. The modem platform may further include digital baseband circuitry 436, transmit circuitry 438, receive circuitry 440, RF circuitry 442, RFFE circuitry 444, and antenna panels 446. The components of the AN 404 may be similar to and substantially interchangeable with like-named components of the UE 402. In addition to performing data transmission/reception as described above, the components of the AN 408 may perform various logical functions that include, for example, RNC functions such as radio bearer management, uplink and downlink dynamic radio resource management, and data packet scheduling.

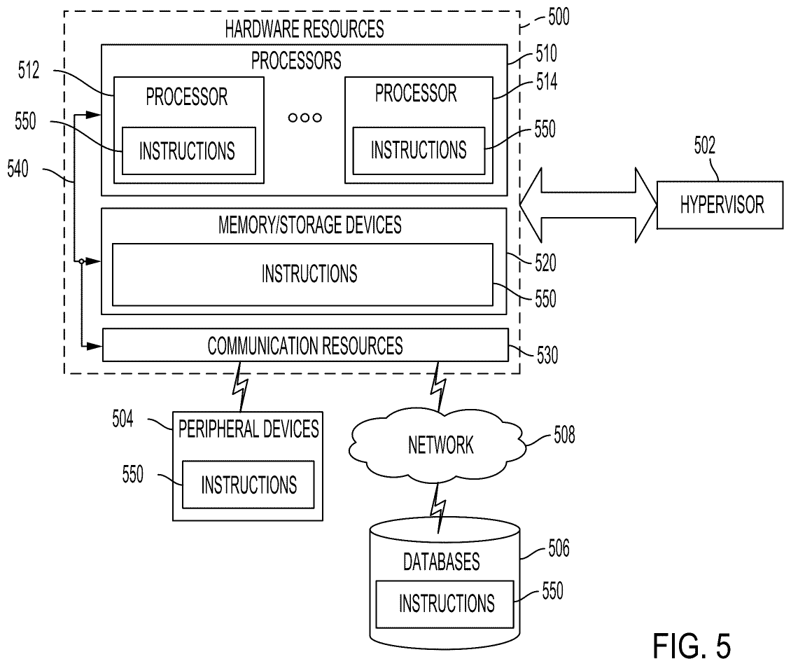

FIG. 5 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 5 shows a diagrammatic representation of hardware resources 500 including one or more processors (or processor cores) 510, one or more memory/storage devices 520, and one or more communication resources 530, each of which may be communicatively coupled via a bus 540 or other interface circuitry. For embodiments where node virtualization (e.g., NFV) is utilized, a hypervisor 502 may be executed to provide an execution environment for one or more network slices/sub-slices to utilize the hardware resources 500.

The processors 510 may include, for example, a processor 512 and a processor 514. The processors 510 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 520 may include main memory, disk storage, or any suitable combination thereof. The memory/storage devices 520 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 530 may include interconnection or network interface controllers, components, or other suitable devices to communicate with one or more peripheral devices 504 or one or more databases 506 or other network elements via a network 508. For example, the communication resources 530 may include wired communication components (e.g., for coupling via USB, Ethernet, etc.), cellular communication components, NFC components, Bluetooth® (or Bluetooth® Low Energy) components, Wi-Fi® components, and other communication components.

Instructions 550 may comprise software, a program, an application, an applet, an app, or other executable code for causing at least any of the processors 510 to perform any one or more of the methodologies discussed herein. The instructions 550 may reside, completely or partially, within at least one of the processors 510 (e.g., within the processor's cache memory), the memory/storage devices 520, or any suitable combination thereof. Furthermore, any portion of the instructions 550 may be transferred to the hardware resources 500 from any combination of the peripheral devices 504 or the databases 506. Accordingly, the memory of processors 510, the memory/storage devices 520, the peripheral devices 504, and the databases 506 are examples of computer-readable and machine-readable media.

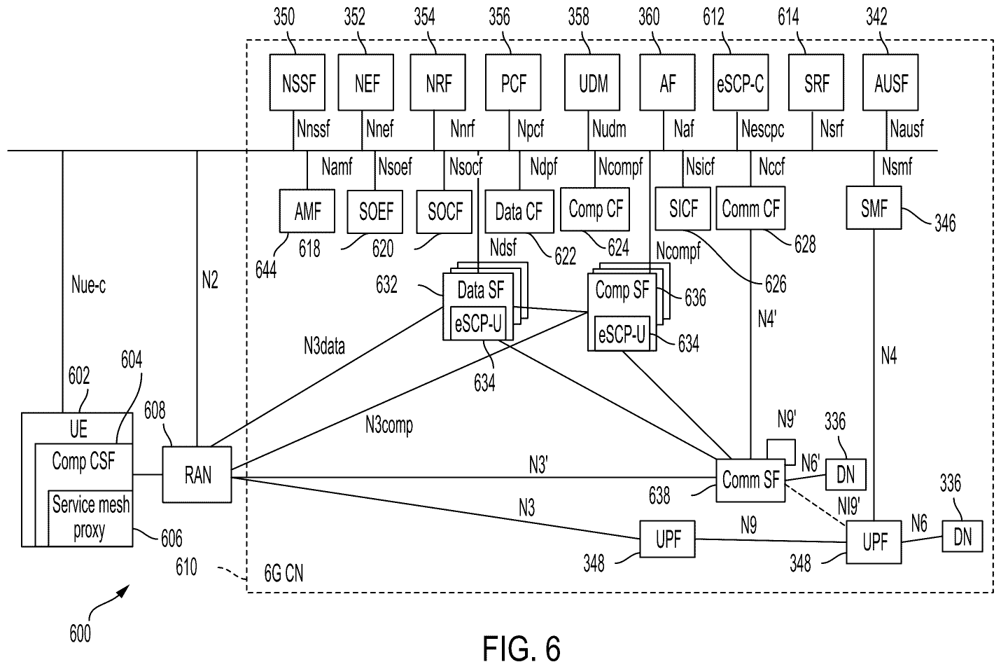

FIG. 6 illustrates a network 600 in accordance with various embodiments. The network 600 may operate in a matter consistent with 3GPP technical specifications or technical reports for 6G systems. In some embodiments, the network 600 may operate concurrently with network 300. For example, in some embodiments, the network 600 may share one or more frequency or bandwidth resources with network 300. As one specific example, a UE (e.g., UE 602) may be configured to operate in both network 600 and network 300. Such configuration may be based on a UE including circuitry configured for communication with frequency and bandwidth resources of both networks 300 and 600. In general, several elements of network 600 may share one or more characteristics with elements of network 300. For the sake of brevity and clarity, such elements may not be repeated in the description of network 600.

The network 600 may include a UE 602, which may include any mobile or non-mobile computing device designed to communicate with a RAN 608 via an over-the-air connection. The UE 602 may be similar to, for example, UE 302. The UE 602 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 6, in some embodiments the network 600 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 6, the UE 602 may be communicatively coupled with an AP such as AP 306 as described with respect to FIG. 3. Additionally, although not specifically shown in FIG. 6, in some embodiments the RAN 608 may include one or more ANss such as AN 308 as described with respect to FIG. 3. The RAN 608 and/or the AN of the RAN 608 may be referred to as a base station (BS), a RAN node, or using some other term or name.

The UE 602 and the RAN 608 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 608 may allow for communication between the UE 602 and a 6G core network (CN) 610. Specifically, the RAN 608 may facilitate the transmission and reception of data between the UE 602 and the 6G CN 610. The 6G CN 610 may include various functions such as NSSF 350, NEF 352, NRF 354, PCF 356, UDM 358, AF 360, SMF 346, and AUSF 342. The 6G CN 610 may additional include UPF 348 and DN 336 as shown in FIG. 6.

Additionally, the RAN 608 may include various additional functions that are in addition to, or alternative to, functions of a legacy cellular network such as a 4G or 5G network. Two such functions may include a Compute Control Function (Comp CF) 624 and a Compute Service Function (Comp SF) 636. The Comp CF 624 and the Comp SF 636 may be parts or functions of the Computing Service Plane. Comp CF 624 may be a control plane function that provides functionalities such as management of the Comp SF 636, computing task context generation and management (e.g., create, read, modify, delete), interaction with the underlying computing infrastructure for computing resource management, etc. . . . Comp SF 636 may be a user plane function that serves as the gateway to interface computing service users (such as UE 602) and computing nodes behind a Comp SF instance. Some functionalities of the Comp SF 636 may include: parse computing service data received from users to compute tasks executable by computing nodes; hold service mesh ingress gateway or service API gateway; service and charging policies enforcement; performance monitoring and telemetry collection, etc. In some embodiments, a Comp SF 636 instance may serve as the user plane gateway for a cluster of computing nodes. A Comp CF 624 instance may control one or more Comp SF 636 instances.

Two other such functions may include a Communication Control Function (Comm CF) 628 and a Communication Service Function (Comm SF) 638, which may be parts of the Communication Service Plane. The Comm CF 628 may be the control plane function for managing the Comm SF 638, communication sessions creation/configuration/releasing, and managing communication session context. The Comm SF 638 may be a user plane function for data transport. Comm CF 628 and Comm SF 638 may be considered as upgrades of SMF 346 and UPF 348, which were described with respect to a 5G system in FIG. 3. The upgrades provided by the Comm CF 628 and the Comm SF 638 may enable service-aware transport. For legacy (e.g., 4G or 5G) data transport, SMF 346 and UPF 348 may still be used.

Two other such functions may include a Data Control Function (Data CF) 622 and Data Service Function (Data SF) 632 may be parts of the Data Service Plane. Data CF 622 may be a control plane function and provides functionalities such as Data SF 632 management, Data service creation/configuration/releasing, Data service context management, etc. Data SF 632 may be a user plane function and serve as the gateway between data service users (such as UE 602 and the various functions of the 6G CN 610) and data service endpoints behind the gateway. Specific functionalities may include: parse data service user data and forward to corresponding data service endpoints, generate charging data, report data service status.

Another such function may be the Service Orchestration and Chaining Function (SOCF) 620, which may discover, orchestrate and chain up communication/computing/data services provided by functions in the network. Upon receiving service requests from users, SOCF 620 may interact with one or more of Comp CF 624, Comm CF 628, and Data CF 622 to identify Comp SF 636, Comm SF 638, and Data SF 632 instances, configure service resources, and generate the service chain, which could contain multiple Comp SF 636, Comm SF 638, and Data SF 632 instances and their associated computing endpoints. Workload processing and data movement may then be conducted within the generated service chain. The SOCF 620 may also responsible for maintaining, updating, and releasing a created service chain.

Another such function may be the service registration function (SRF) 614, which may act as a registry for system services provided in the user plane such as services provided by service endpoints behind Comp SF 636 and Data SF 632 gateways and services provided by the UE 602. The SRF 614 may be considered a counterpart of NRF 354, which may act as the registry for network functions.

Other such functions may include an evolved service communication proxy (eSCP) and service infrastructure control function (SICF) 626, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 612 and eSCP-U 634, for control plane service communication proxy and user plane service communication proxy, respectively. The SICF 626 may control and configure eCSP instances in terms of service traffic routing policies, access rules, load balancing configurations, performance monitoring, etc.

Another such function is the AMF 644. The AMF 644 may be similar to 344, but with additional functionality. Specifically, the AMF 644 may include potential functional repartition, such as move the message forwarding functionality from the AMF 644 to the RAN 608.

Another such function is the service orchestration exposure function (SOEF) 618. The SOEF may be configured to expose service orchestration and chaining services to external users such as applications.

The UE 602 may include an additional function that is referred to as a computing client service function (comp CSF) 604. The comp CSF 604 may have both the control plane functionalities and user plane functionalities, and may interact with corresponding network side functions such as SOCF 620, Comp CF 624, Comp SF 636, Data CF 622, and/or Data SF 632 for service discovery, request/response, compute task workload exchange, etc. The Comp CSF 604 may also work with network side functions to decide on whether a computing task should be run on the UE 602, the RAN 608, and/or an element of the 6G CN 610.

The UE 602 and/or the Comp CSF 604 may include a service mesh proxy 606. The service mesh proxy 606 may act as a proxy for service-to-service communication in the user plane. Capabilities of the service mesh proxy 606 may include one or more of addressing, security, load balancing, etc.

### Example Procedures

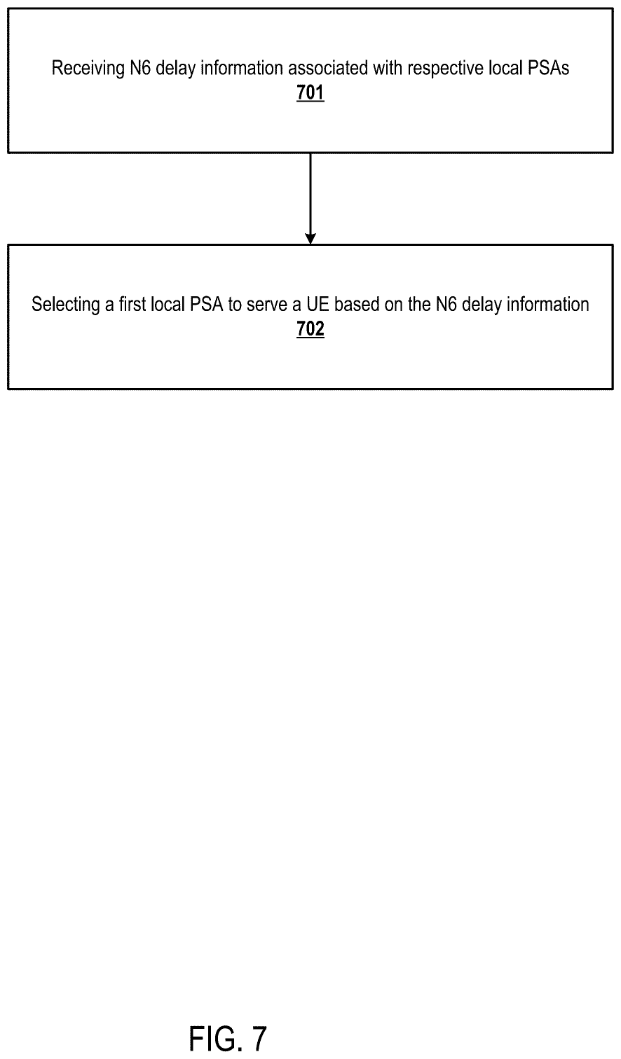

In some embodiments, the electronic device(s), network(s), system(s), chip(s) or component(s), or portions or implementations thereof, of FIGS. 3-6, or some other figure herein, may be configured to perform one or more processes, techniques, or methods as described herein, or portions thereof. One such process is depicted in FIG. 7. In some embodiments, the process may be performed by a session management function (SMF) or a portion thereof. At 701, the process may include receiving N6 delay information associated with respective local protocol data unit (PDU) session anchors (PSAs). At 702, the process may further include selecting a first local PSA to serve a user equipment (UE) based on the N6 delay information.

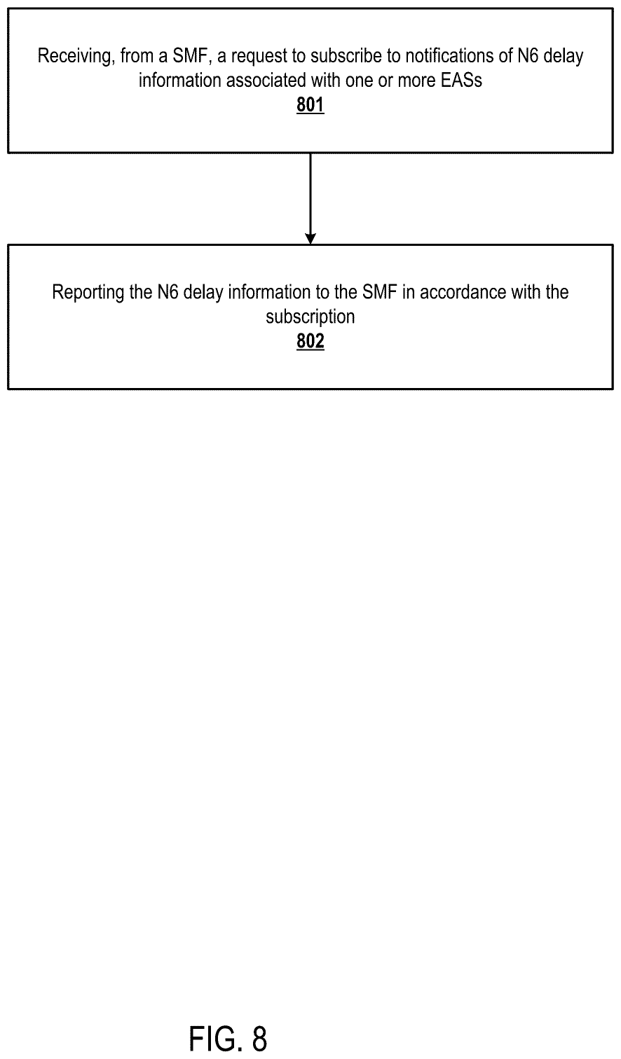

FIG. 8 illustrates another example process in accordance with various embodiments. In some embodiments, the process may be performed by a local protocol data unit (PDU) session anchors (PSAs). At 801, the process may include receiving, from a session management function (SMF), a request to subscribe to notifications of N6 delay information associated with one or more edge application servers (EASs). At 802, the process may further include reporting the N6 delay information to the SMF in accordance with the subscription.

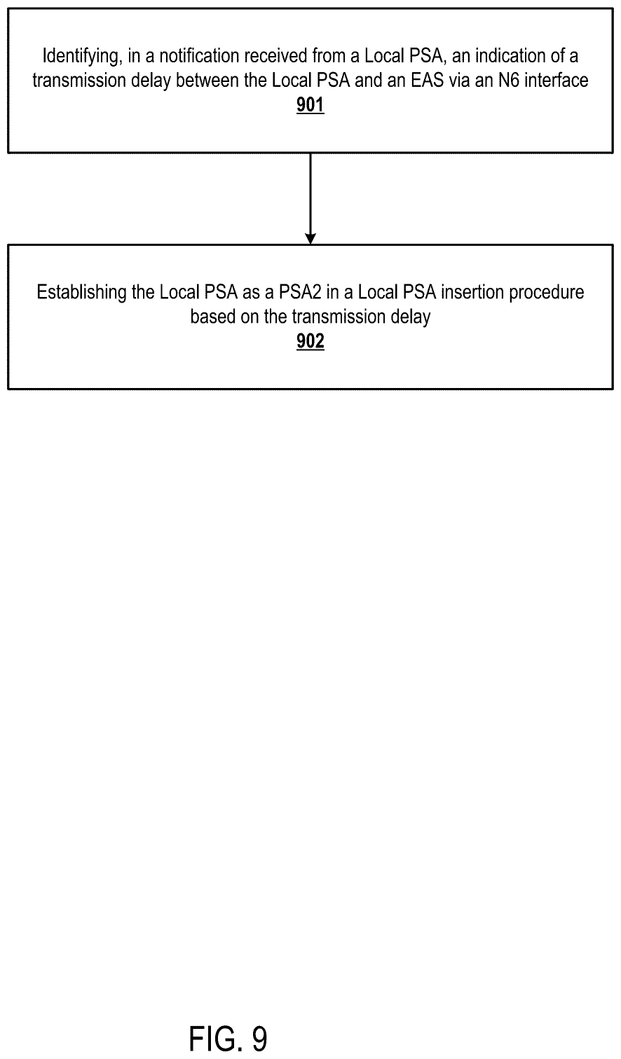

FIG. 9 illustrates an alternative example process in accordance with various embodiments herein. The process of FIG. 9 may include or relate to a method to be implemented by a session management function (SMF), one or more elements of a SMF, and/or one or more electronic devices that include and/or implement an SMF. The process may include identifying, at 901 in a notification received from a Local protocol data unit session anchor (PSA), an indication of a transmission delay between the Local PSA and an edge application server (EAS) via an N6 interface; and establishing, at 902, the Local PSA as a PSA2 in a Local PSA insertion procedure based on the transmission delay.

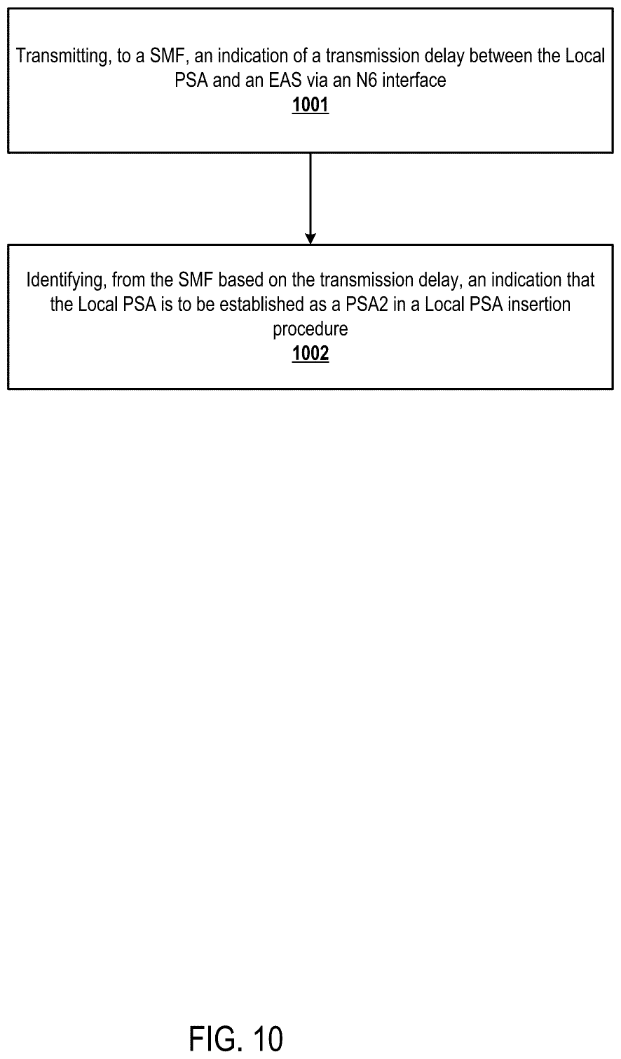

FIG. 10 illustrates an alternative example process in accordance with various embodiments herein. The process of FIG. 10 may include or relate to a method to be implemented by a Local protocol data unit session anchor (PSA), one or more elements of a Local PSA, and/or one or more electronic devices that include and/or implement a Local PSA. The process may include transmitting, at 1001 to a session management function (SMF), an indication of a transmission delay between the Local PSA and an edge application server (EAS) via an N6 interface; and identifying, at 1002 from the SMF based on the transmission delay, an indication that the Local PSA is to be established as a PSA2 in a Local PSA insertion procedure.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 may include the method for supporting Local PSA UPF selection taking account of N6 delay information.

Example 2 may include the method of Example 1 and/or some other example herein, whereby the SMF selects the Local PSA UPF taking account of N6 delay information during the Local PSA UPF addition procedure.

Example 3 may include the method of Example 2 and/or some other example herein, whereby the SMF subscribes to Local PSA UPF, when the notification trigger is met, the Local PSA UPF notifies SMF about the N6 delay information between PSA UPF and EAS.

Example 4 may include the method of Example 2 and/or some other example herein, whereby the N6 delay information is represented as Round-trip time in milliseconds.

Example 5 may include the method of Example 3 and/or some other example herein, whereby the Local PSA UPF is configured to report the N6 delay information to SMF in a time interval.

Example 6 may include the method of Example 3 and/or some other example herein, whereby the Local PSA UPF is configured to report the N6 delay in the range of N6 delay change.

Example 7 may include the method of Example 3 and/or some other example herein, whereby the N6 delay subscription is per EAS identifier.

Example 8 may include the method of Example 7 and/or some other example herein, whereby the EAS identifier is FQDN(s).

Example 9 may include the method of Example 7 and/or some other example herein, whereby the EAS identifier is FQDN range.

Example 10 may include the method of Example 7 and/or some other example herein, whereby the EAS identifier is IP address(es).

Example 11 may include the method of Example 7 and/or some other example herein, whereby the EAS identifier is IP range.

Example 12 may include a method of a session management function (SMF), the method comprising:
receiving N6 delay information associated with respective local protocol data unit (PDU) session anchors (PSAs); and
selecting a first local PSA to serve a user equipment (UE) based on the N6 delay information.

Example 13 may include the method of example 12 and/or some other example herein, wherein the first local PSA is selected as part of a local PSA user plane function (UPF) addition procedure.

Example 14 may include the method of example 12-13 and/or some other example herein, wherein the N6 delay information is received from the respective local PSAs.

Example 15 may include the method of example 14 and/or some other example herein, wherein the N6 delay information is received in accordance with a subscription.

Example 16 may include the method of example 12-15 and/or some other example herein, wherein the N6 delay information is received based on occurrence of a triggering event.

Example 17 may include the method of example 16 and/or some other example herein, wherein the triggering event includes a passing of a time interval or the N6 delay information being above or below one or more thresholds.

Example 18 may include the method of example 12-17 and/or some other example herein, wherein the N6 delay information corresponds to a round trip time in milliseconds.

Example 19 may include the method of example 12-18 and/or some other example herein, wherein the N6 delay information is further associated with one or more edge application servers (EASs).

Example 20 may include the method of example 15-19 and/or some other example herein, wherein the subscription is associated with one or more EASs.

Example 21 may include the method of example 20 and/or some other example herein, wherein the one or more EASs correspond to one or more fully qualified domain names (FQDNs), a range of FQDNs, one or more Internet protocol (IP) addresses, and/or a range of IP addresses.

Example 22 may include the method of example 20-21 and/or some other example herein, wherein the subscription is for one or more EAS identifiers.

Example 23 may include a method of a local protocol data unit (PDU) session anchors (PSAs), the method comprising:
receiving, from a session management function (SMF), a request to subscribe to notifications of N6 delay information associated with one or more edge application servers (EASs); and
reporting the N6 delay information to the SMF in accordance with the subscription.

Example 24 may include the method of example 23 and/or some other example herein, wherein the N6 delay information is reported based on occurrence of a triggering event.

Example 25 may include the method of example 24 and/or some other example herein, wherein the triggering event includes a passing of a time interval or the N6 delay information being above or below one or more thresholds.

Example 26 may include the method of example 23-25 and/or some other example herein, wherein the N6 delay information corresponds to a round trip time in milliseconds.

Example 27 may include the method of example 23-26 and/or some other example herein, wherein the subscription is for one or more EAS identifiers.

Example 28 may include the method of example 23-27 and/or some other example herein, wherein individual EAS identifiers correspond to one or more fully qualified domain names (FQDNs), a range of FQDNs, one or more Internet protocol (IP) addresses, and/or a range of IP addresses.

Example 29 may include a method to be implemented by a session management function (SMF), one or more elements of a SMF, and/or one or more electronic devices that include and/or implement an SMF, wherein the method comprises: identifying, in a notification received from a Local protocol data unit session anchor (PSA), an indication of a transmission delay between the Local PSA and an edge application server (EAS) via an N6 interface; and establishing the Local PSA as a PSA2 in a Local PSA insertion procedure based on the transmission delay.

Example 30 may include the method of example 29, and/or one or more other examples herein, wherein the indication of the transmission delay between the Local PSA and the EAS is a round trip time (RTT) between the Local PSA and the EAS via the N6 interface.

Example 31 may include the method of any one or more of examples 29-30, and/or one or more other examples herein, wherein receipt of the notification is based on subscription, by the SMF, to notifications from the Local PSA regarding the transmission delay via the N6 interface.

Example 32 may include the method of any one ro more of examples 29-31, and/or one or more other examples herein, wherein receipt of the notification is based on identification, by the Local PSA, of occurrence of a notification condition related to the transmission delay via the N6 interface.

Example 33 may include the method of example 32, and/or one or more other examples herein, wherein the notification condition is related to a threshold value for the transmission delay.

Example 34 may include the method of any one or more of examples 32-33, and/or one or more other examples herein, wherein the notification condition is related to an amount of change in the transmission delay.

Example 35 may include the method of any one or more of examples 29-34, and/or one or more other examples herein, wherein the Local PSA is one of a plurality of Local PSAs that are candidates for use as the PSA2.

Example 36 may include the method of any one or more of examples 29-35, and/or one or more other examples herein, wherein the Local PSA is communicatively coupled with a plurality of EASs and configured to provide one or more notifications related to respective transmission delays between the Local PSA and respective ones of the plurality of EASs.

Example 37 may include a method to be implemented by a Local protocol data unit session anchor (PSA), one or more elements of a Local PSA, and/or one or more electronic devices that include and/or implement a Local PSA, wherein the method comprises: transmitting, to a session management function (SMF), an indication of a transmission delay between the Local PSA and an edge application server (EAS) via an N6 interface; and identifying, from the SMF based on the transmission delay, an indication that the Local PSA is to be established as a PSA2 in a Local PSA insertion procedure.

Example 38 may include the method of example 37, and/or one or more other examples herein, wherein the indication of the transmission delay between the Local PSA and the EAS is a round trip time (RTT) between the Local PSA and the EAS via the N6 interface.

Example 39 may include the method of any one or more of examples 37-38, and/or one or more other examples herein, wherein the transmission of the indication is based on subscription, by the SMF, to notifications from the Local PSA regarding the transmission delay via the N6 interface.

Example 40 may include the method of any one or more of examples 37-39, and/or one or more other examples herein, wherein transmission of the indication is based on identification, by the Local PSA, of occurrence of a notification condition related to the transmission delay via the N6 interface.

Example 41 may include the method of example 40, and/or one or more other examples herein, wherein the notification condition is related to a threshold value for the transmission delay.

Example 42 may include the method of any one or more of examples 40-41, and/or one or more other examples herein, wherein the notification condition is related to an amount of change in the transmission delay.

Example 43 may include the method of any one or more of examples 37-42, and/or one or more other examples herein, wherein the Local PSA is one of a plurality of Local PSAs that are candidates for use as the PSA2.

Example 44 may include the method of any one or more of examples 37-43, and/or one or more other examples herein, wherein the Local PSA is communicatively coupled with a plurality of EASs and configured to provide one or more notifications related to respective transmission delays between the Local PSA and respective ones of the plurality of EASs.

Example Z01 may include an apparatus comprising means to perform one or more elements of a method described in or related to any of examples 1-44, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-44, or any other method or process described herein.

Example Z03 may include an apparatus comprising logic, modules, or circuitry to perform one or more elements of a method described in or related to any of examples 1-44, or any other method or process described herein.

Example Z04 may include a method, technique, or process as described in or related to any of examples 1-44, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-44, or portions thereof.

Example Z06 may include a signal as described in or related to any of examples 1-44, or portions or parts thereof.

Example Z07 may include a datagram, packet, frame, segment, protocol data unit (PDU), or message as described in or related to any of examples 1-44, or portions or parts thereof, or otherwise described in the present disclosure.

Example Z08 may include a signal encoded with data as described in or related to any of examples 1-44, or portions or parts thereof, or otherwise described in the present disclosure.

Example Z09 may include a signal encoded with a datagram, packet, frame, segment, protocol data unit (PDU), or message as described in or related to any of examples 1-44, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-44, or portions thereof.

Example Z11 may include a computer program comprising instructions, wherein execution of the program by a processing element is to cause the processing element to carry out the method, techniques, or process as described in or related to any of examples 1-44, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

1. One or more non-transitory computer-readable media (NTCRM) comprising instructions that, upon execution of the instructions by one or more processors of an electronic device, are to cause a session management function (SMF) to:
identify, in a notification received from a Local protocol data unit session anchor (PSA), an indication of a transmission delay between the Local PSA and an edge application server (EAS) via an N6 interface; and
establish the Local PSA as a PSA2 in a Local PSA insertion procedure based on the transmission delay.

2. The one or more NTCRM of claim 1, wherein the indication of the transmission delay between the Local PSA and the EAS is a round trip time (RTT) between the Local PSA and the EAS via the N6 interface.

3. The one or more NTCRM of claim 1, wherein receipt of the notification is based on subscription, by the SMF, to notifications from the Local PSA regarding the transmission delay via the N6 interface.

4. The one or more NTCRM of claim 1, wherein receipt of the notification is based on identification, by the Local PSA, of occurrence of a notification condition related to the transmission delay via the N6 interface.

5. The one or more NTCRM of claim 4, wherein the notification condition is related to a threshold value for the transmission delay.

6. The one or more NTCRM of claim 4, wherein the notification condition is related to an amount of change in the transmission delay.

7. The one or more NTCRM of claim 1, wherein the Local PSA is one of a plurality of Local PSAs that are candidates for use as the PSA2.

8. The one or more NTCRM of claim 1, wherein the Local PSA is communicatively coupled with a plurality of EASs and configured to provide one or more notifications related to respective transmission delays between the Local PSA and respective ones of the plurality of EASs.

9. One or more non-transitory computer-readable media (NTCRM) comprising instructions that, upon executions of the instructions by one or more processors of an electronic device, are configured to cause a Local protocol data unit session anchor (PSA) to:
transmit, to a session management function (SMF), an indication of a transmission delay between the Local PSA and an edge application server (EAS) via an N6 interface; and
identify, from the SMF based on the transmission delay, an indication that the Local PSA is to be established as a PSA2 in a Local PSA insertion procedure.

10. The one or more NTCRM of claim 9, wherein the indication of the transmission delay between the Local PSA and the EAS is a round trip time (RTT) between the Local PSA and the EAS via the N6 interface.

11. The one or more NTCRM of claim 9, wherein the transmission of the indication is based on subscription, by the SMF, to notifications from the Local PSA regarding the transmission delay via the N6 interface.

12. The one or more NTCRM of claim 9, wherein transmission of the indication is based on identification, by the Local PSA, of occurrence of a notification condition related to the transmission delay via the N6 interface.

13. The one or more NTCRM of claim 12, wherein the notification condition is related to a threshold value for the transmission delay.

14. The one or more NTCRM of claim 12, wherein the notification condition is related to an amount of change in the transmission delay.

15. The one or more NTCRM of claim 9, wherein the Local PSA is one of a plurality of Local PSAs that are candidates for use as the PSA2.

16. The one or more NTCRM of claim 9, wherein the Local PSA is communicatively coupled with a plurality of EASs and configured to provide one or more notifications related to respective transmission delays between the Local PSA and respective ones of the plurality of EASs.

17. An electronic device comprising:
one or more processors configured to implement a session management function (SMF); and
memory comprising instructions that, upon execution of the instructions by the one or more processors, are to cause the SMF to:
identify, in a notification received from a Local protocol data unit session anchor (PSA), an indication of a transmission delay between the Local PSA and an edge application server (EAS) via an N6 interface; and
establish the Local PSA as a PSA2 in a Local PSA insertion procedure based on the transmission delay.

18. The electronic device of claim 17, wherein the indication of the transmission delay between the Local PSA and the EAS is a round trip time (RTT) between the Local PSA and the EAS via the N6 interface.

19. The electronic device of claim 17, wherein receipt of the notification is based on subscription, by the SMF, to notifications from the Local PSA regarding the transmission delay via the N6 interface.

20. The electronic device of claim 17, wherein receipt of the notification is based on identification, by the Local PSA, of occurrence of a notification condition related to the transmission delay via the N6 interface.
